(19) United States
(12) Patent Application Publication
(10) Pub. No.: US 2021/0106937 A1
(43) Pub. Date: Apr. 15, 2021

(54) FILTER CARTRIDGE INCLUDING PATTERNED FUNCTIONAL MATERIAL

(71) Applicant: 3M INNOVATIVE PROPERTIES COMPANY, St. Paul, MN (US)

(72) Inventors: Austin D. Groth, Minneapolis, MN (US); Derek M. Maanum, Minneapolis, MN (US); Reyad A. Abdulqader, Stockton-On-Tees (GB); Shawn C. Dodds, St. Paul, MN (US); Ann M. Gilman, Bayport, MN (US); Duane D. Fansler, Dresser, WI (US); Britton G. Billingsley, St. Paul, MN (US)

(21) Appl. No.: 17/053,079

(22) PCT Filed: May 6, 2019
(86) PCT No.: PCT/IB2019/053685

§ 371 Date: Nov. 5, 2020

Related U.S. Application Data
(60) Provisional application No. 62/668,395, filed on May 8, 2018.

(51) Int. Cl. B01D 46/00; B01D 46/24; B01D 39/14; B01J 20/20; B01J 20/28; B32B 5/02; B32B 7/12; B32B 5/16; B32B 5/24; B32B 5/32

(52) U.S. Cl. CPC B01D 46/0036; A62B 9/006; B01D 46/2411; B01D 46/0086; B01D 46/0001; B01D 39/14; B01J 20/20; B01J 20/2803; B01J 20/28035; B32B 5/022; B32B 7/12; B32B 5/16; B32B 5/24; B32B 5/32; B01D 2271/02; B01D 2275/10; B01D 2239/0407; B01D 2239/045; B01D 2239/0681; B32B 2262/0276; B32B 2262/0253; B01D 46/0038

(57) ABSTRACT

Various embodiments of a filter cartridge are disclosed. The filter cartridge includes a first filter media layer having first and second major surfaces, a second filter media layer having first and second major surfaces, and a plenum disposed between the first and second filter media layers. The filter cartridge further includes functional material disposed on the first major surface of each of the first and second filter media layers within a filter region of the filter cartridge, where the functional material includes active particles disposed on an adhesive layer; and a perimeter seal region that defines at least a portion of a perimeter of the filter cartridge, where at least the first and second filter media layers are connected together in the perimeter seal region. The functional material is not disposed in at least a portion of the perimeter seal region.

### BACKGROUND

Personnel that work in contaminated environments commonly wear respirators to help protect themselves from inhaling contaminants that are suspended in the surrounding air. The respirators—also referred to as “filtering face masks”—may have a filter cartridge or element integral to the mask body (see, e.g., U.S. Pat. No. 5,307,796 to Kronzer et al.) or that is separately attachable to the mask body (see, e.g., U.S. Pat. No. 5,579,761 to Yuschak et al.). In either instance, the respirator helps to protect the wearer from airborne particles or unpleasant or noxious gases over the useful service life of the filter cartridge. To achieve this goal, the filter cartridge needs to remove the contaminants without early clogging and with minimal effort or energy requirements for the wearer. Because the wearer commonly supplies the energy needed to draw air through filter media of the filter cartridge, less resistance to airflow means that the wearer does not need to work as hard to breathe clean air, thereby providing a more comfortable respirator. This resistance of air movement through the filter media is commonly referred to as “pressure drop.” Lower pressure drops across filter cartridges of respirators allow air to be filtered with greater ease. Further, wearer comfort is important in respirator design because the wearer is more likely to remove an uncomfortable respirator when in a contaminated environment. In addition to providing lower pressure drops, the respirator also should fit comfortably on the face without stress to the neck and without obstructing the wearer's field of view.

Various respirators can include active or functional particulate materials that interact with fluids by sorbing (adsorbing or absorbing) components from the fluids. For example, respirators can include microporous sorbents that purify workplace breathing air. Activated carbon, i.e., an active or functional particulate having sorptive properties, is widely used to filter air to remove at least a portion of a variety of toxic or noxious vapors, including war gases, industrial chemicals, solvents, and odorous compounds. The activated carbon is derived, for example, from coal or coconut shells and can be produced in the form of powders, granules, and shaped products.

In addition to activated carbon, there are other porous sorbent structures that can be useful for separating components in gas and liquid streams or for purifying such streams. Examples of other porous sorbent structures include silica gel and activated alumina. Other sorbents include crystalline aluminosilicates or zeolites or molecular sieve adsorbents and metal-organic framework (MOFs).

### SUMMARY

In general, the present disclosure provides various embodiments of a filter cartridge and a respirator that includes such filter cartridge. The filter cartridge can include first and second filter media layers and a plenum disposed between the filter media layers. Functional material can be disposed on or in at least one of the first and second filter media layers and the plenum, where the functional material includes active particles disposed on an adhesive layer. The first and second filter media layers can be connected together in a perimeter seal region that defines at least a portion of a perimeter of the filter cartridge. In one or more embodiments, the functional material is not disposed in the perimeter seal region.

In one aspect, the present disclosure provides a filter cartridge that includes a first filter media layer having a first major surface and a second major surface, a second filter media layer having a first major surface and a second major surface, and a plenum disposed between the first and second filter media layers. The filter cartridge further includes functional material disposed on the first major surface of each of the first and second filter media layers within a filter region of the filter cartridge, where the functional material includes active particles disposed on an adhesive layer; and a perimeter seal region that defines at least a portion of a perimeter of the filter cartridge, where at least the first and second filter media layers are connected together in the perimeter seal region. The functional material is not disposed in at least a portion of the perimeter seal region.

In another aspect, the present disclosure provides a method of forming a filter cartridge that includes forming a first filter media layer and a second filter media layer, where each of the first and second filter media layers includes a first major surface and a second major surface; selectively disposing functional material on the first major surface of each of the first and second filter media layers, where the functional material includes active particles disposed on an adhesive layer; and disposing a plenum between the first and first filter media layers. The method further includes connecting the first filter media layer to the second filter media layer together to form a perimeter seal region that defines at least a portion of a perimeter of the filter cartridge, where the functional material is not disposed in at least a portion of the perimeter seal region.

All headings provided herein are for the convenience of the reader and should not be used to limit the meaning of any text that follows the heading, unless so specified.

The terms “comprises” and variations thereof do not have a limiting meaning where these terms appear in the description and claims. Such terms will be understood to imply the inclusion of a stated step or element or group of steps or elements but not the exclusion of any other step or element or group of steps or elements.

In this application, terms such as “a,” “an,” and “the” are not intended to refer to only a singular entity, but include the general class of which a specific example may be used for illustration. The terms “a,” “an,” and “the” are used interchangeably with the term “at least one.” The phrases “at least one of” and “comprises at least one of” followed by a list refers to any one of the items in the list and any combination of two or more items in the list.

The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise.

The term “and/or” means one or all of the listed elements or a combination of any two or more of the listed elements.

As used herein in connection with a measured quantity, the term “about” refers to that variation in the measured quantity as would be expected by the skilled artisan making the measurement and exercising a level of care commensurate with the objective of the measurement and the precision of the measuring equipment used. Herein, “up to” a number (e.g., up to 50) includes the number (e.g., 50).

Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

### GLOSSARY

The terms set forth below will have the meanings as defined:

“bonded” means contact between two or more filaments that results in a restriction of movement between those filaments relative to each other;

“clean air” means air that has been filtered so that it is safer for a person to inhale;

“compliant face contacting member” means the portion of a mask body that is compliantly fashioned for allowing the mask body to be comfortably supported over a person's nose and mouth;

“contaminants” means a substance that is intended to be removed from the gas or liquid being filtered;

“continuous” means filaments that are not cut to a desired length;

“exterior gas space” means the ambient atmospheric gas space that surrounds a mask body of a respirator when worn by a wearer and that ultimately receives exhaled gas after it exits the interior gas space of a respirator;

“filter media” means a material, or a combination of materials, that are able to remove contaminants from a fluid that passes therethrough;

“fluid communication component” means an element that is structured to allow a fluid to pass from an interior gas space to an exterior gas space or vice versa;

“fluid inlet” means an area or portion of the filter cartridge through which fluid can enter;

“fluid outlet” means an area or portion of the filter cartridge through which fluid can exit;

“harness” means an element or combination of elements or parts, which elements or combination allows a mask body to be supported at least over a wearer's nose and mouth;

“interior gas space” means the space that exists between a mask body and a person's face when the respirator is being worn;

“mask body” means a structure that can fit at least over the nose and mouth of the wearer and that can help define an interior gas space separated from an exterior gas space;

“non-integral” means the parts are readily identifiable as separate parts by exterior visual examination and that they are separately made before being joined together;

“plenum” means a part or a combination of parts that are capable of distributing or managing fluid flow over a surface of a filter media;

“respirator” means a device that is worn at least over the nose and mouth of the wearer and that includes at least one filter media for providing clean air for the wearer to breathe;

“visual appearance” means an appearance of an indicator zone of a visual life indicator to a human wearer or user in ordinary room light on a light-to-dark spectrum (e.g., the “color” or “shade” of the zone on a white-black scale);

“visual filter life reference zone” means an area of an outer surface of the filter cartridge that can be visually inspected by a wearer or user and that exhibits an initial appearance that is significantly different from that of a visual filter life indicator zone, and whose appearance does not change appreciably as the filter is used; and

“visual filter life indicator zone” means an area of the outer surface of the filter cartridge that can be visually inspected by a wearer or user, with the visual appearance of the indicator zone providing an indication of whether the filter cartridge is approaching the end of its useful lifetime.

These and other aspects of the present disclosure will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

Throughout the specification, reference is made to the appended drawings, where like reference numerals designate like elements, and wherein:

FIG. 1 is a schematic perspective view of one embodiment of a respirator that includes one or more filter cartridges.

FIG. 2 is a schematic cross-section view of one filter cartridge of the respirator of FIG. 1.

FIG. 3 is a schematic cross-section view of a portion of the filter cartridge of FIG. 2.

FIG. 4 is a schematic plan view of a front surface of the filter cartridge of FIG. 2.

FIG. 5 is a schematic plan view of another embodiment of a filter cartridge.

FIG. 6 is a schematic plan view of another embodiment of a filter cartridge that includes a visual life indicator.

FIG. 7 is a flowchart of one embodiment of a method of forming a filter cartridge.

### DETAILED DESCRIPTION

In general, the present disclosure provides various embodiments of a filter cartridge and a respirator that includes such filter cartridge. The filter cartridge can include first and second filter media layers and a plenum disposed between the filter media layers. Functional material can be disposed on or in at least one of the first and second filter media layers and the plenum, where the functional material includes active particles disposed on an adhesive layer. The first and second filter media layers can be connected together in a perimeter seal region that defines at least a portion of a perimeter of the filter cartridge. In one or more embodiments, the functional material is not disposed in the perimeter seal region.

When manufacturing respirators, additional performance characteristics can be added to the overall capability of filter cartridges for such respirators by including additional layers to the construction. For example, a layer of a carbon-carrying (i.e., carbon-loaded) nonwoven web can be added to one or more layers of particulate filter media and one or more cover webs to aid in removing nuisance odors from the ambient air, thereby providing a “nuisance odor level” of protection. The term “nuisance odor level” commonly refers to any product that removes any low-level residual odors from an environment. Common respirators that provide at least a minimal level of nuisance odor protection typically include a layer or layers of carbon-loaded melt-blown microfibers along with one or more particulate filter layers.

Attaching these carbon-loaded layers to other layers of the filter cartridge can, however, be challenging as carbon particles from the loaded layers tend to leak out of the layers through edges of the filter cartridge. Such particles can also prevent connectors or fittings disposed through the filter cartridge from properly sealing, thereby reducing the effectiveness of the respirator to properly filter ambient gas. Forming the filter cartridge can also generate an abundance of fine dust that causes cross contamination if the manufacturing line isn't cleaned thoroughly.

One or more embodiments of filter cartridges of the present application can advantageously include functional material disposed within a filter region of the filter cartridge and not in regions of the cartridge where welding or cutting operations are required for forming the cartridge. For example, in one or more embodiments, such functional material is not disposed in at least a portion of a perimeter seal region or other seal regions of the filter cartridge.

Removing functional material from the seal regions of filter cartridges may provide cost-savings by reducing trim waste of the functional material currently being cut-off of such cartridges where the functional material is deposited in both filter regions and non-filter regions. Further, because the functional material can be deposited only in the airflow filter regions of the filter cartridge, such material may not be present in the edge and seal zones nor in the area connected to a fitting or conduit. This approach can further reduce carbon waste and prevent leakage of functional material from the edges of the cartridge. Also, by disposing functional material directly onto filter media and not onto a carrier layer that is then disposed on the filter media of the filter cartridge, the number of layers present in the cartridge can be reduced. This can yield additional cost savings and result in a less-bulky filter cartridge. By reducing the number of layers within the filter cartridge, the airflow resistance of the cartridge is lower than one that contains additional layers of carbon media, thereby resulting in a product that is easier to breathe through.

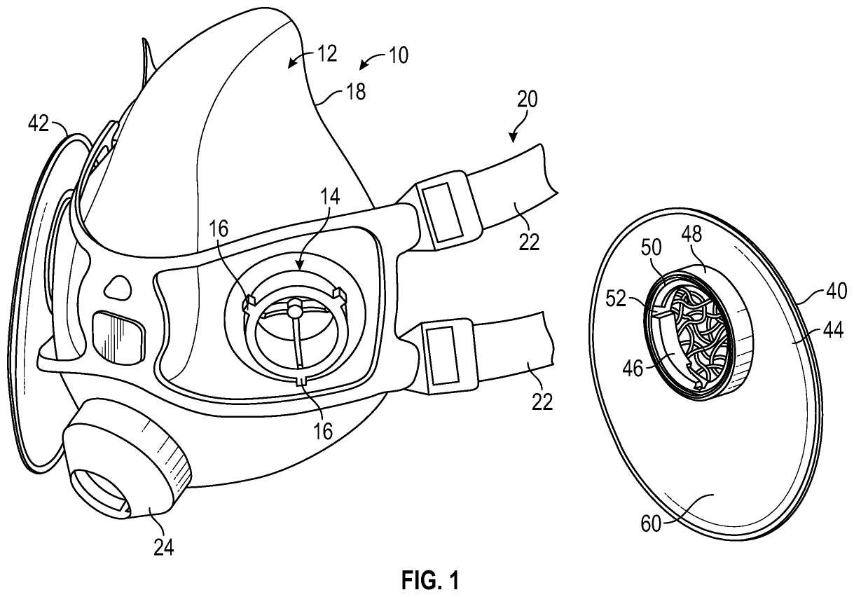

The various embodiments of filter cartridges described herein can be utilized with any suitable respirator. For example, FIG. 1 is a schematic perspective view of one embodiment of a respirator 10 that includes a filter cartridge 40 and a second filter cartridge 42. The first and second filter cartridges 40, 42 can be disposed on opposing sides of a mask body 12 of the respirator 10. The filter cartridges 40, 42 can be removably or permanently attached to the mask body 12.

The respirator 10 can include identical first and second filter cartridges 40, 42 (collectively referred to herein as filter cartridge 40). In one or more embodiments, the first filter cartridge 40 can be different from the second filter cartridge 42. Although the various aspects of the first filter cartridge 40 will be described herein in greater detail, such aspects apply equally to the second filter cartridge 42.

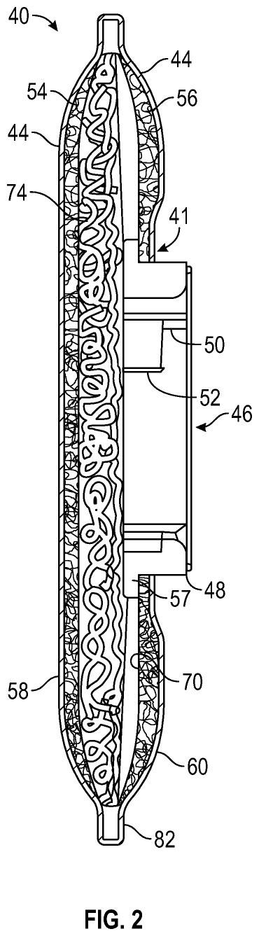

The filter cartridge 40 includes a front surface 58 (FIG. 2) and a rear surface 60. The filter cartridge 40 also includes a fluid inlet 44 through which air may enter an interior space of the filter cartridge. The fluid inlet 44 is a porous outer covering through which air-to-be-filtered passes when a wearer of the respirator 10 inhales. At least one of the front and rear surfaces 58, 60 can include the fluid inlet 44.

The filter cartridge 40 also has a fluid outlet 46, which is in the form of an orifice that is defined by interior walls 50 of a conduit 48. Any suitable connector can be utilized to connect the filter cartridge 40 to the mask body 12. As shown in FIG. 1, a male bayonet fitting 14 can be provided on the mask body 12 for securing the filter cartridge 40 thereto. The bayonet fitting 14 can include a plurality of spaced protuberances 16 that mate with channels 52 in the conduit 48. The filter cartridge 40 can be attached to the bayonet fitting 14 by inserting the protuberances 16 into the corresponding channels 52 and rotating the filter cartridge in the appropriate direction. Replacement of the filter cartridge 40 can be accomplished by rotating the filter cartridge or mask body 12 in the opposite direction relative to each other. A more detailed description of a bayonet-type fitting that is suitable for use in connection with the present invention is described, e.g., in U.S. Pat. No. 5,720,281 to Allen et al. Other suitable filter cartridge attachment; mechanisms are described, e.g., in U.S. Pat. No. 5,062,421 to Burns et al.; U.S. Pat. No. 6,277,178 to Holmquist-Brown et al.; U.S. Pat. No. 7,650,884 to Flannigan et al.; and U.S. Pat. No. 7,320,722 to Mittelstadt et al.

As further shown in FIG. 1, the mask body 12 includes a compliant face contacting member 18 and a harness 20. The face contacting member 18 conforms to the wearer's face when pressed against it. The harness 20 can be attached to the mask body 12 so that the respirator 10 can be supported on (and drawn to) the wearer's face. The harness 20 can include one or more straps 22 that pass behind (or over) the wearer's head when the respirator is donned. The straps 22 can be adjustable and/or elastic so that the mask body 12 can be snugly positioned on a variety of head sizes. The harness 20 can also include a crown member (see, e.g., U.S. Pat. No. 6,591,837 to Byram) to help support the respirator 10 on the wearer's face. Examples of harnesses that can be used with a respirator of the present disclosure include those described, e.g., in U.S. Pat. Nos. 6,715,490, and 6,119,692 to Byram et al., and in U.S. Pat. Nos. 6,732,733 and 6,457,473 to Brostrom et al.

An exhalation valve 24 can also be provided on the mask body 12 to enable exhaled air to be purged from the mask interior. Examples of suitable exhalation valves are described, e.g., in U.S. Pat. No. 7,013,895 to Martin et al.; U.S. Pat. No. 6,883,518 to Mittelstadt et al.; U.S. Pat. No. 6,854,463 to Japuntich et al.; and RE37,974 to Bowers. These exhalation valves all include a flexible flap that dynamically opens in response to exhaled air.

Air that is inhaled by the wearer passes, in sequence, through the fluid inlet 44, filter media 54, 56 (FIG. 2), and then the outlet 46 of the filter cartridge 40. The filtered air then enters an interior gas space of the mask body 12 as clean air that the respirator wearer may inhale. Air that is subsequently exhaled by the wearer also enters the interior gas space where it is then purged from the mask interior through the exhalation valve 24 to enter an exterior gas space. Respirator wearers can perform fit testing to ascertain whether the mask properly fits the wearer (see, e.g., U.S. Pat. No. 6,955,170 to Mullins et al.) so that clean and exhaled air can enter an interior gas space breathing zone.

Although depicted as including a half mask that has first and second filter cartridges 40, 42, the respirator 10 can include any suitable mask bodies and filter cartridges. For example, the respirator 10 can have a single filter cartridge that is centrally mounted as shown, e.g., in U.S. Pat. No. 6,277,178 to Holmquist-Brown; U.S. Pat. No. 6,216,693 to Rekow et al.; or U.S. Pat. No. 5,579,761 to Yuschak et al. The respirator 10 can also include a full-face mask body as described, e.g., in U.S. Pat. No. 5,924,420 to Reischel et al. and U.S. Pat. No. 6,895,960 to Fabin.

Additionally, the various respirators and filter cartridges described herein can be utilized with a powered-air supply source, which includes an air supply hose attached to the mask body rather than filter cartridge(s). See, e.g., U.S. Pat. No. 6,796,304 to Odell et al. and U.S. Pat. No. 6,575,165 to Cook et al. In this instance, the filter cartridge would be disposed in a cartridge worn by the wearer, typically around the waist, and the mask body would be in fluidic communication therewith through the air supply hose. Air can be forced through the filter media by a powered air supply source that may include a fan and an electric motor. Further, the respirator also can be in the form of an escape hood. See, e.g., U.S. Pat. No. D480,476 to Martinson et al., and U.S. Pat. Nos. 6,302,103; 6,371,116; and 6,701,925 to Resnick.

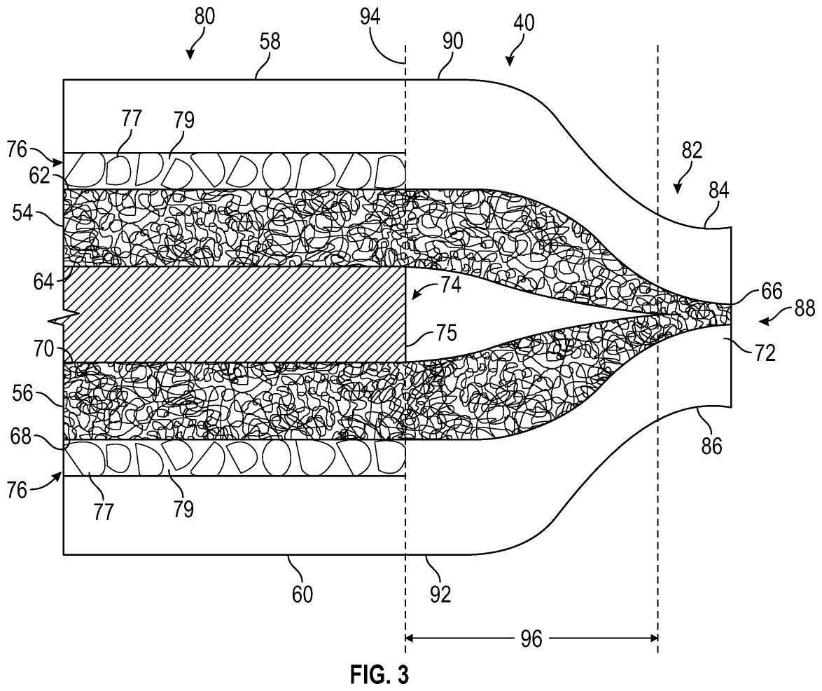

Any suitable filter cartridge or cartridges can be utilized with respirator 10. As shown in FIGS. 2-4, the filter cartridge 40 includes a first filter media layer 54 that includes a first major surface 62 and a second major surface 64. The first filter media layer 54 extends to an edge 66 as shown in FIG. 3. The filter cartridge 40 also includes a second filter media layer 56 that includes a first major surface 68 and a second major surface 70. The second filter media layer 56 extends to an edge 72. Although depicted as including first and second filter media layers 54, 56, the filter cartridge 40 can include any suitable number of filter media layers. A plenum 74 is disposed between the first and second filter media layers 54, 56. In one or more embodiments, the plenum 74 can be disposed between the first and second filter media layers 54, 56 such that the plenum interfaces with the second major surfaces 64, 70 of the first and second filter media layers. As used herein, the term “interface” means that the plenum 74 is disposed such that it is in contact with at least a portion of each of the second surfaces 64, 70 of the first and second filter media layers 54, 56.

Further, functional material 76 is disposed on the first major surface 62 of the first filter media layer 54 and the first major surface 68 of the second filter media layer 56 within a filter region 80 of the filter cartridge 40, where the functional material includes active particles 77 disposed on or in an adhesive layer 79. A perimeter seal region 82 defines at least a portion of a perimeter 88 of the filter cartridge 40, where at least the first and second filter media layers 54, 56 are connected together. In one or more embodiments, the functional material 76 is not disposed in at least a portion of the perimeter seal region 82.

In one or more embodiments, the filter cartridge 40 can also include at least one of a front cover web 84 disposed over or on the functional material 76 and the first filter media layer 54, and a rear cover web 86 disposed over or on the functional material 76 and second filter media layer 56. When present, the front cover web 84 provides the front surface 58 of the filter cartridge 40 and the rear cover web 86 provides the rear surface 60.

The front and rear cover webs 84, 86 can include any suitable material as is further described herein. Such cover webs 84, 86 can protect and contain filter media 54, 56 and may serve as an upstream prefilter layer. The selection of materials for the front and rear cover webs 84, 86 can depend upon design factors known to those skilled in the art, such as the type of environment in which a respirator 10 is expected to be used, and performance requirements such as pressure drop, the type and amount of dust, mist, or fume to be removed from the air in the exterior gas space. While the front and rear cover webs 84, 86 of the filter cartridge 40 can each include a single layer of filter or cover web material, a plurality of layers may be used for added performance.

In one or more embodiments, the first and second filter media layers 54, 56, the plenum 74, and functional material 76 can be disposed within a housing (not shown). The housing can be rigid to contain larger quantities of filter material and/or to protect it from damage. Examples of filter cartridges or elements that have filter media contained within a housing are shown, e.g., in U.S. Pat. No. 5,714,126 to Frund; U.S. Pat. No. 4,867,770 to Feeney; and U.S. Pat. No. 4,277,443 to Van der Smissen, et al.

The perimeter seal region 82 includes two or more layers of the filter cartridge 40 that are connected together to form a seal or bond. In one or more embodiments, at least one or more of the front cover web 84, the rear cover web 86, the first filter media layer 54, the second filter media layer 56, and the plenum 74 are connected together in the perimeter seal region 82. In one or more embodiments, the front cover web 84 and the rear cover web 86 are connected together in the perimeter seal region 82. In one or more embodiments, the front cover web 84, the rear cover web 86, and the first and second filter media layers 54, 56 are connected together in the perimeter seal region 82. Any suitable technique or combination of techniques can be utilized to form the perimeter seal region 82. For example, the perimeter seal region 82 can be formed using ultrasonic welding, thermal bonding, adhesive attachment, mechanical attachment, and combinations thereof. In one or more embodiments, an edge 75 of the plenum 74 does not extend into the perimeter seal region 82.

The perimeter seal region 82 can, in one or more embodiments, extend from the filter region 80 of the filter cartridge 40 to the perimeter 88 of the filter cartridge 40. The perimeter seal region 82 can take any suitable shape or combination of shapes. Further, the perimeter seal region 82 can also include any suitable dimensions. For example, the perimeter seal region 82 can have any suitable width extending from the perimeter 88 to the filter region 80 in a direction orthogonal to a surface normal of the front surface 58 of the filter cartridge 40. The perimeter seal region 82 can extend along any suitable portion or portions of the perimeter 88 of the filter cartridge 40. In one or more embodiments, the perimeter seal region 82 can extend along the entire perimeter 88 of the filter cartridge 40, i.e., the seal region defines the entire perimeter of the filter cartridge 40. In one or more embodiments, the perimeter seal region 82 defines at least a portion of the perimeter 88 of the filter cartridge 40.

In general, the first and second filter media layers 54, 56 can include any suitable filter media. For example, filter media utilized for the first and second filter media layers 54, 56 can generally be low in pressure drop (e.g., less than about 195 to 295 Pascals at a face velocity of 13.8 centimeters per second) to minimize the breathing work of the mask wearer. Filter media for first and second filter media layers 54, 56 can also be flexible and have sufficient shear strength so that they generally retain their structure under the expected use conditions. Examples of particle capture filters include one or more webs of fine inorganic fibers (such as fiberglass) or polymeric synthetic fibers. Synthetic fiber webs may include electret-charged polymeric microfibers that are produced from processes such as meltblowing. Polyolefin microfibers formed from polypropylene that has been electrically charged can provide utility for particulate capture applications.

In one or more embodiments, each of the first and second filter media layers 54, 56 can include one or more filtration layers. Any suitable filtration layer or layers can be included in filter media layers 54, 56. The filtration layer generally will remove a high percentage of particles and/or or other contaminants from the gaseous stream that passes through it. For fibrous filter layers, the fibers selected depend upon the kind of substance to be filtered and, typically, are chosen so that they do not become bonded together during the manufacturing operation. As indicated, the filtration layer may come in a variety of shapes and forms and typically has a thickness of about 0.2 millimeters (mm) to 1 centimeter (cm), more typically about 0.3 mm to 0.5 cm, and it could be a generally planar web or it could be corrugated to provide an expanded surface area. See, e.g., U.S. Pat. Nos. 5,804,295 and 5,656,368 to Braun et al. The filter media layers 54, 56 also may include multiple filtration layers.

Any suitable material that is known (or later developed) for forming a filtration layer may be used as the filtering material. In one or more embodiments, webs of melt-blown fibers, such as those taught in Wente, Van A., Superfine Thermoplastic Fibers, 48 Indus. Eng. Chem., 1342 et seq. (1956), especially when in a persistent electrically charged (electret) form can be utilized (see, e.g., U.S. Pat. No. 4,215,682 to Kubik et al.). These melt-blown fibers may be microfibers that have an effective fiber diameter less than about 20 micrometers (μm) (referred to as BMF for “blown microfiber”), typically about 1 to 12 μm. Effective fiber diameter may be determined according to Davies, C. N., The Separation Of Airborne Dust Particles, Institution Of Mechanical Engineers, London, Proceedings 1B, 1952. In one or more embodiments, the filtration layer can include one or more BMF webs that contain fibers formed from polypropylene, poly(4-methyl-1-pentene), and combinations thereof. Electrically charged fibrillated-film fibers as taught in U.S. Pat. Re. 31,285 to van Turnhout also may be suitable, as well as rosin-wool fibrous webs and webs of glass fibers or solution-blown, or electrostatically sprayed fibers, especially in microfiber form. Electric charge can be imparted to the fibers by contacting the fibers with water as disclosed in U.S. Pat. No. 6,824,718 to Eitzman et al.; U.S. Pat. No. 6,783,574 to Angadjivand et al.; U.S. Pat. No. 6,743,464 to Insley et al.; U.S. Pat. Nos. 6,454,986 and 6,406,657 to Eitzman et al.; and U.S. Pat. Nos. 6,375,886 and 5,496,507 to Angadjivand et al. Electric charge also may be imparted to the fibers by corona charging as disclosed in U.S. Pat. No. 4,588,537 to Klasse et al., or by tribocharging as disclosed in U.S. Pat. No. 4,798,850 to Brown. Also, additives can be included in the fibers to enhance the filtration performance of webs produced through the hydro-charging process (see U.S. Pat. No. 5,908,598 to Rousseau et al.). Fluorine atoms, in particular, can be disposed at the surface of the fibers in the filter layer to improve filtration performance in an oily mist environment. See, e.g., U.S. Pat. Nos. 6,398,847 B1, 6,397,458 B1, and 6,409,806 B1 to Jones et al. Typical basis weights for electret BMF filtration layers are about 10 to 100 grams per square meter (g/m²). When electrically charged according to techniques described in, e.g., the '507 Angadjivand et al. patent, and when including fluorine atoms as mentioned in the Jones et al. patents, the basis weight may be about 20 to 40 g/m² and about 10 to 30 g/m², respectively.

In one or more embodiments, the filter cartridge 40 can also include functional material 76. The functional material 76 can be disposed in any suitable location on or in the filter cartridge 40. For example, in the embodiment illustrated in FIGS. 2-4, the functional material 76 is disposed in the filter region 80 of the filter cartridge 40. Further, the functional material 76 can be disposed between one or more of the various layers of the filter cartridge 40. For example, as illustrated in FIG. 3, the functional material 76 is disposed between the front cover web 84 and the first filter media layer 54 on the first major surface 62 of the first filter media layer. Further, the functional material 76 is also disposed between the rear cover web 86 and the second filter media layer 56 on the first major surface 68 of the second filter media. In one or more embodiments, the functional material 76 can be disposed between the first filter media layer 54 and the plenum 74. In one or more embodiments, the functional material 76 can be disposed between the second filter media 56 and the plenum 74. Further, in one or more embodiments, the functional material 76 can be disposed within at least one of the front cover web 84, the rear cover web 86, the first and second filter media layers 54, 56, and the plenum 74.

In one or more embodiments, at least one of the first and second filter media layers 54, 56 can include one or more filtration layers. In such embodiments, the functional material 76 can be disposed on or within one or more filtration layers of at least one of the first and second filter media layers 54, 56. Further, in one or more embodiments, the functional material 76 can be disposed between two or more filtration layers of at least one of the first and second filter media layers 54, 56.

In one or more embodiments, the functional material 76 can be disposed on the front surface 58 of the filter cartridge 40, the rear surface 60 of the filter cartridge, or on both of the outer surfaces of the filter cartridge. In embodiments where the filter cartridge 40 includes the front cover web 84, the functional material 76 can be disposed on an outer surface 90 of the front cover web. In addition, in embodiments where the filter cartridge 40 includes a rear cover web 86, the function material 76 can be disposed on an outer surface 92 of the rear cover web.

In one or more embodiments, the functional material 76 can be disposed on a carrier layer or scrim layer that is connected to one or more of the various layers of the filter cartridge 40, e.g., first filter media layer 54.

The functional material 76 can include any suitable material or combination of materials that can absorb or remove one or more gases or particulates from air passing into the filter cartridge 40 through one or both of the front surface 58 and the rear surface 60. For example, in one or more embodiments, the functional material 76 can include a layer that includes sorptive materials such as activated carbon. Further, separate particulate filtration layers may be used with sorptive layers to provide filtration for both particulates and vapors. The sorbent component may be used for removing hazardous or odorous gases from the breathing air. Sorbents may include powders or granules that are bound in a filter layer by adhesives, binders, or fibrous structures. See, e.g., U.S. Pat. No. 6,234,171 to Springett et al. and U.S. Pat. No. 3,971,373 to Braun.

For example, a variety of active particles can be employed as sorbents. In one or more embodiments, the active particles are capable of absorbing or adsorbing gases, aerosols, or liquids expected to be present under the intended service conditions. The active particles can be in any useful form including beads, flakes, granules, fibers, or agglomerates. Exemplary active particles include activated carbon, alumina, and other metal oxides, clay, hopcalite, and other catalysts, ion exchange resins, molecular sieves, and other zeolites, silica, sodium bicarbonate, biocides, fungicides, MOFs, and virucides. Mixtures of particles can be employed, e.g., to absorb mixtures of gases.

The functional material 76 can include any suitable size or combination of sizes of active particles. For example, in one or more embodiments, the active particles can have a mesh size of 6×8 (3.36×2.38 mm), 12×20 (1.68×0.84 mm), 20×50 (0.84×0.297 mm), 32×60 (0.545×0.25 mm), 40×200 (0.42×0.074 mm), 80×400 (0.177×0.037 mm), etc. In general, the functional material 76 can include any suitable distribution of particle sizes of active particles. In one or more embodiments, the functional material 76 can include a first portion of active particles having a first mesh size and a second portion of active particles having a second mesh size that is different from the first mesh size to provide a bimodal distribution of active particles. For example, in one or more embodiments, the functional material 76 can include a first portion of active particles having a mesh size of 12×20, and a second portion of active particles having a mesh size of 32×60. Further, for example, in one or more embodiments, the functional material 76 can include first, second, and third portions of active particles to provide a trimodal distribution of active particle sizes.

A sorbent layer can be formed by coating a substrate, such as fibrous or reticulated foam, to form a thin coherent layer. Sorbent materials may include activated carbons that are chemically treated or not, porous alumna-silica catalyst substrates, and alumna particles. An example of a sorptive filtering structure that may be conformed into various configurations is described in U.S. Pat. No. 6,391,429 to Senkus et al.

The functional material 76 can be disposed on or within the filter cartridge 40 using any suitable technique or combination of techniques. For example, the functional material 76 can include active particles disposed on or in the adhesive layer or layers 79 that is disposed on or within the filter cartridge 40. For example, the adhesive layer 79 can be disposed, e.g., on the first major surface 62 of the first filter media layer 54, and active particles can be disposed on or within the adhesive layer using any suitable technique or combination of techniques to provide the functional material 76. The adhesive layer 79 can be a continuous layer. In one or more embodiments, the adhesive layer 79 can be a patterned adhesive layer that includes any suitable pattern or combination of patterns.

The adhesive layer or layers 79 can include any suitable material or combination of materials, e.g., structural adhesives, pressure-sensitive adhesives (e.g., acrylic-based pressure-sensitive adhesives), hot melt adhesives, epoxies, etc.

The active particles 77 can be disposed on or in the adhesive layer 79 using any suitable technique or combination of techniques. For example, in embodiments where the functional material 76 includes a bimodal distribution of active particle sizes, a first portion of active particles having a first mesh size can be disposed on or in the adhesive layer 79, and a second portion of active particles having a second mesh size can be disposed over the first portion of active particles. In one or more embodiments, the first mesh size of the first portion of active particles 77 can be greater than the second mesh size of the second portion of active particles. While not wishing to be bound by any particular theory, in such embodiments, the active particles of the second portion that have the smaller mesh size can be disposed in one or more of the spaces between the active particles of the first portion that have a larger mesh size such that the particles of the second portion of active particles fill one or more of the spaces between the particles of the first portion of active particles. In embodiments where the functional material 76 includes a trimodal distribution of active particle sizes, a third portion of active particles having a third mesh size that is smaller than both the first and second mesh sizes can be disposed over the first and second portions of active particles. In other words, the active particles 77 of the functional material 76 can be disposed in two or more layers of decreasing sizes of particles, two or more layers of increasing sizes of particles, or a gradient of layers of different sizes of particles.

The functional material 76 can include any suitable density or densities of active particles 77. In one or more embodiments, the functional material 76 can include at least 50 g/m² and no greater than 600 g/m² of active particles. In one or more embodiments, the functional material 76 can include at least 130 g/m² and no greater than 170 g/m² of active particles 77.

As mentioned herein, the functional material 76 can be disposed in any suitable location on or within the filter cartridge 40. In one or more embodiments, the functional material 76 can be disposed such that it is not in at least a portion of the perimeter seal region 82. In other words, in some embodiments, one or more portions of the perimeter seal region 82 do not include the functional material 76. For example, as illustrated in FIG. 3, the functional material 76 disposed on the first and second filter media layers 54, 56 includes a boundary or edge 94 that is spaced apart from the perimeter seal region 82 a distance 96. The distance 96 can be any suitable distance. In one or more embodiments, distance 96 can be no greater than 4 mm. In one or more embodiments, the distance 96 can be about 0 mm. The distance 96 can include a treatment to one or more of the front cover web 84, rear cover web 86, first and second filter media layers 54, 56, and plenum 74 to reduce air flow or even be made air impermeable. This treatment may be a compression of layers, e.g., an ultrasonic weld, or an added sealant, e.g., hot melt or other adhesive.

In one or more embodiments, the functional material 76 is disposed in no greater than 50% of a total area of the perimeter seal region 82. Further, in one or more embodiments, the functional material 76 is disposed in no greater than 10% of the total area of the perimeter seal region 82. In one or more embodiments, the functional material 76 is disposed in no greater than 5% of the total area of the perimeter seal region 82. And in one or more embodiments, the functional material 76 is disposed in no greater than 1% of the total area of the perimeter seal region 82.

The functional material 76 can be disposed in a continuous layer or can be disposed in a patterned configuration to provide patterned functional material. As shown in FIG. 4, which is a schematic plan view of the front surface 58 of the filter cartridge 40 with the front cover web 84 removed for illustrative purposes, the functional material 76 is disposed on the first major surface 62 of the first filter media layer 54 as a continuous layer.

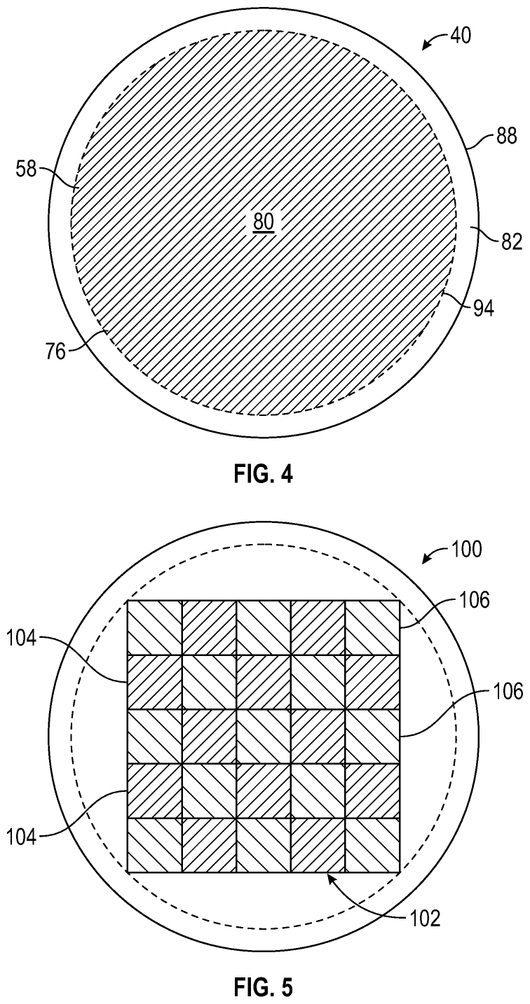

In contrast to the filter cartridge 40 as shown in FIG. 4, FIG. 5 is a schematic plan view of another embodiment of a filter cartridge 100. All of the design considerations and possibilities regarding the filter cartridge 40 of FIGS. 1-4 apply equally to the filter cartridge 100 of FIG. 5. Filter cartridge 100 includes functional material 102 disposed on or within the filter cartridge 100 in a first pattern 104 and a second pattern 106. The functional material 102 can be disposed on or within the filter cartridge 100 in any suitable location. For example, in one or more embodiments, the functional material 102 can be disposed on a first filter media layer (e.g., disposed on the first major surface 62 of the first filter media layer 54 of cartridge 40) in the first pattern 104, and on a second filter media layer (e.g., disposed on the first major surface 68 of the second filter media layer 56 of cartridge 40) in the second pattern 106.

The first pattern 104 of functional material 102 can be the same as the second pattern 106. In one or more embodiments, the first pattern 104 can be different from the second pattern 106. For example, as shown in FIG. 5, the first pattern 104 is different from the second pattern 106 in that the first pattern is offset from the second pattern in a direction normal to the plane of the figure.

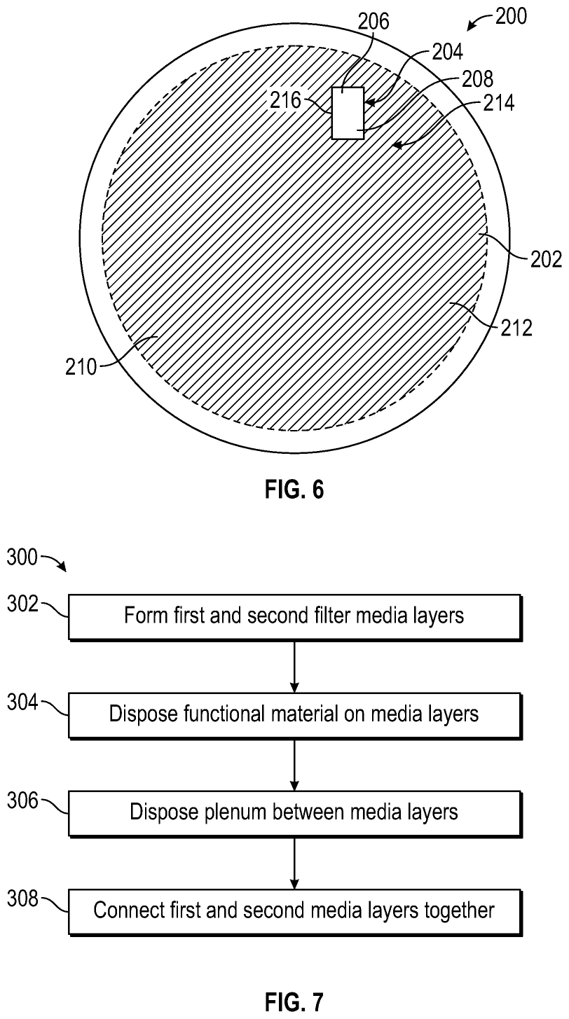

In one or more embodiments, a filter cartridge can include a visual filter life indicator zone. For example, FIG. 6 is a schematic plan view of a front surface 202 of a filter cartridge 200. All of the design considerations and possibilities regarding the filter cartridge 40 of FIGS. 1-4 apply equally to the filter cartridge 200 of FIG. 6. The filter cartridge 200 includes a visual life indicator 204 on the front surface 202. The visual life indicator 204 includes an area 206 that is free of functional material to provide at least one sorbent-free visual filter life indicator zone 208. The appearance of the visual filter life indicator zone 208 will change appreciably as the filter cartridge 200 is used due to the accumulation of particles that are captured by filter media.

The filter cartridge 200 also includes functional material 210 disposed in any suitable location on or in the filter cartridge 200 to provide a sorbent-loaded zone 212. The sorbent-loaded zone 212 provides a visual filter life reference zone 214. The visual reference zone 214 acts as a reference (e.g., a target) to which the visual appearance of the visual filter life indicator zone 208 can be compared. The visual appearance of the visual filter life indicator zone 208 approaching that of the reference zone 214 is an indication that the filter cartridge 200 is approaching the end of its useful lifetime.

When the filter cartridge 200 is first utilized, sorbent-free visual filter life indicator zone 208 will exhibit an initial light-colored appearance (e.g., a white or off-white color, as shown in FIG. 6). Sorbent-loaded visual reference zone 214 will exhibit an initial color that is much darker (due to the presence of e.g. activated carbon), e.g. very dark grey or black, also as shown in FIG. 6. There will thus be an easily recognizable contrast between the visual appearance of the indicator zone 208 provided by the sorbent-free area 206, and the visual appearance of the visual reference zone 214 provided by the sorbent-loaded zone 212. In particular, boundaries 216 between indicator zone 208 and reference zone 214 may be easily discernable. Over time, as airborne particles are captured by the filter cartridge 200, sorbent-free area 206 will darken in appearance.

While some airborne particles will also be captured by fibers of filter cartridge 200 that underlie the sorbent-loaded zone 212, the dark color imparted by the sorbent particles will dominate the appearance of a sorbent-loaded area such that any darkening of this area due to capture of airborne particles will be generally negligible. In other words, the sorbent-loaded zone 212 will at least substantially retain its initial dark appearance during the usable lifetime of the filter and thus can act to provide the visual reference zone 214. Over time, visual filter life indicator zone 208 will darken so that it approaches visual reference zone 214 in appearance. A user may thus obtain an indication of whether the filter cartridge 200 is approaching the end of its useful lifetime for particulate filtration, by evaluating how closely, on a light-dark spectrum, the visual appearance of indicator zone 208 has come to resemble the visual appearance of reference zone 214.

Returning to FIGS. 1-4, the front and rear cover webs 84, 86 can be located on the first major surfaces 62, 68 of the first and second filter media layers 54, 56 to capture any fibers that could come loose therefrom. The front and rear cover webs 84, 86 also may have filtering abilities. The cover webs 84, 86 may be made from nonwoven fibrous materials such as spun bonded fibers that contain, e.g., polyolefins, and polyesters. See, e.g., U.S. Pat. No. 6,041,782 to Angadjivand et al.; U.S. Pat. No. 4,807,619 to Dyrud et al.; and U.S. Pat. No. 4,536,440 to Berg. When a wearer inhales, air is drawn through the filter cartridge 40, and airborne particles become trapped in the interstices between the fibers, particularly the fibers in the filter layer.

A typical cover web may be made from polypropylene or a polypropylene/polyolefin blend that contains 50 weight percent or more polypropylene. These materials have been found to offer high degrees of softness and comfort to the wearer and also, when the filter material is a polypropylene BMF material, to remain secured to the filter material without requiring an adhesive between the layers. Polyolefin materials that are suitable for use in a cover web may include, for example, a single polypropylene, blends of two polypropylenes, and blends of polypropylene and polyethylene, blends of polypropylene and poly(4-methyl-1-pentene), and/or blends of polypropylene and polybutylene. One example of a fiber for the cover web is a polypropylene BMF made from the polypropylene resin “Escorene 3505G” from Exxon Corporation, providing a basis weight of about 25 g/m²and having a fiber denier in the range 0.2 to 3.1 (with an average, measured over 100 fibers of about 0.8). Another suitable fiber is a polypropylene/polyethylene BMF (produced from a mixture comprising 85% of the resin “Escorene 3505G” and 15 percent of the ethylene/alpha-olefin copolymer “Exact 4023” also from Exxon Corporation) providing a basis weight of about 25 g/m² and having an average fiber denier of about 0.8. Suitable spunbond materials are available under the trade designations “Corosoft Plus 20,” “Corosoft Classic 20” and “Corovin PP S 14,” from Corovin GmbH of Peine, Germany, and a carded polypropylene/viscose material available, under the trade designation “370/15,” from J. W. Suominen OY of Nakila, Finland. Cover webs typically have very few fibers protruding from the web surface after processing and therefore have a smooth outer surface. Examples of cover webs that may be used in a respirator of the present disclosure are described, e.g., in U.S. Pat. No. 6,041,782 to Angadjivand; U.S. Pat. No. 6,123,077 to Bostock et al.; and PCT Publication No. WO 96/28216A to Bostock et al.

Disposed between the first and second filter media layers 54, 56 is the plenum 74, which can include any suitable material or materials, e.g., the same materials described herein regarding the first and second filter media layers. Additional examples of suitable plenum materials are described, e.g., in U.S. Pat. No. 9,216,306 to Angadjivand et al. Although depicted as including one layer, the plenum 74 can include two or more layers. The plenum 74 can take any suitable shape and have any suitable dimensions. In one or more embodiments, the plenum 74 is coextensive with at least one of the first and second filter media layers 54, 56. In one or more embodiments, the plenum 74 is not coextensive with one or both of the first and second filter media layers 54, 56 such that the edge 75 of the plenum does not extend into the perimeter seal region 82 as shown in FIG. 3.

The filter cartridge 40 can also include the conduit 48, which can extend from the plenum 74 (FIG. 2) through an opening 41 in a second filter media layer 56, and a connector 57 disposed on the second major surface 70 of the second filter media layer that is connected to the conduit. The second filter media layer 56 is connected to the connector 57 at a connector seal region (not shown). In one or more embodiments, the functional material 76 is not disposed in at least a portion of the connector seal region.

The various embodiments of filter cartridges described herein can be manufactured using any suitable technique or combination of techniques. See, e.g., U.S. Pat. No. 9,216,306 to Angadjivand et al. For example, FIG. 7 is a schematic perspective view of one embodiment of a manufacturing process 300. In one or more embodiments, the process can be continuous, i.e., the filter cartridge can be manufactured along a manufacturing line without the need to remove the cartridge from the line prior to the completion of the process. The filter cartridge can be formed from a single piece (which single piece can have multiple layers), although multiple pieces can be attached to one another using any suitable technique or combination of techniques, such as a batch process (e.g., by plunge welding) or a continuous process (e.g., rotary welding). Although the process is described in reference to the filter cartridge 40 as illustrated in FIGS. 1-4, the process can be utilized to manufacture any filter cartridge.

The first and second filter media layers 54, 56 can be formed using any suitable technique or combination techniques at 302. At 304, one or more layers of adhesive 79 can be disposed on one or both of the first major surfaces 62, 68 of the first and second filter media layers 54, 56 using any suitable technique or combination of techniques, e.g., one or more printing processes (e.g., screen, gravure, spray). In one or more embodiments, one or more of the adhesive layers 79 can be continuous. In one or more embodiments, the adhesive 79 can be applied as a patterned adhesive layer or layers.

One or more layers of active particles 77 can be selectively disposed on or in the adhesive layers 79 at a coating station to provide functional material 76 on the first and second filter media layers 54, 56. Any suitable technique or combination of techniques can be utilized to dispose active particles 77 on the adhesive layer 79, e.g., water-fall, curtain, etc., such that at least a portion of the active particles is attached to the adhesive layer. In one or more embodiments, the adhesive layer 79 can be selectively disposed on the first major surface 62, 68 of at least one of the first and second filter media layers 54, 56, and the active particles 77 can be disposed on the adhesive layer such that at least a portion of the active particles is attached to the adhesive layer. In one or more embodiments, a portion of the active particles 77 that is not attached to the adhesive layer 79 can be removed using any suitable technique or combination of techniques.

The plenum 74 can be disposed between the first and second filter media layers 54, 56 at 306. In one or more embodiments, at least one of the front cover web 84 and the rear cover web 86 can be disposed on or over the functional material 76 and the first major surfaces 62, 68 of the first and second filter media layers 54, 56 respectively using any suitable technique or techniques. At 308, the first filter media layer 54 can be connected to the second filter media layer 56 to form the perimeter seal region 82 that defines at least a portion of the perimeter 88 of the filter cartridge 40. Further, in one or more embodiments, the front and rear cover webs 84, 86 can be connected together to form the perimeter seal region 82. In one or more embodiments, the functional material 76 is not disposed in at least a portion of the perimeter seal region 82.

The method 300 can also include disposing the conduit 48 within the filter cartridge 40 such that it extends from the plenum 74 through the opening 41 in the second filter media layer 56 using any suitable technique. The connector 57 can be connected to the conduit and the second filter media layer 56 at the connector seal region using any suitable technique or techniques. In one or more embodiments, the function material 76 is not disposed in at least a portion of the connector seal region.

The method 300 can also include forming a visual life indicator (e.g., visual life indicator 204 of filter cartridge 200 of FIG. 6) on the first filter media layer 56 using any suitable technique or techniques. For example, the visual life indicator can be formed by disposing functional material 76 on the first major surface of the first filter media layer 54 to form a visual reference zone (e.g., visual reference zone 214 of FIG. 6) of the visual life indicator, and forming a visual filter life indicator zone (e.g., visual filter life indicator zone 208 of FIG. 6) on the first major surface of the first filter media layer, where the visual filter life indicator zone is free of functional material.

All references and publications cited herein are expressly incorporated herein by reference in their entirety into this disclosure, except to the extent they may directly contradict this disclosure. Illustrative embodiments of this disclosure are discussed and reference has been made to possible variations within the scope of this disclosure. These and other variations and modifications in the disclosure will be apparent to those skilled in the art without departing from the scope of the disclosure, and it should be understood that this disclosure is not limited to the illustrative embodiments set forth herein. Accordingly, the disclosure is to be limited only by the claims provided below.

1. A filter cartridge comprising:
a first filter media layer comprising a first major surface and a second major surface;
a second filter media layer comprising a first major surface and a second major surface;
a plenum disposed between the first and second filter media layers;
functional material disposed on the first major surface of each of the first and second filter media layers within a filter region of the filter cartridge, wherein the functional material comprises active particles disposed on an adhesive layer; and
a perimeter seal region that defines at least a portion of a perimeter of the filter cartridge, wherein at least the first and second filter media layers are connected together in the perimeter seal region;
wherein the functional material is not disposed in at least a portion of the perimeter seal region.

2. The filter cartridge of claim 1, wherein the functional material is disposed in no greater than 50% of a total area of the perimeter seal region.

3. The filter cartridge of claim 1, wherein the functional material is disposed in no greater than 5% of a total area of the perimeter seal region.

4. The filter cartridge of claim 1, wherein the functional material is disposed in no greater than 1% of a total area of the perimeter seal region.

5. The filter cartridge of claim 1, wherein the functional material comprises a patterned functional material.

6. The filter cartridge of claim 1, wherein each of the first and second filter media layers comprises one or more filtration layers.

7. The filter cartridge of claim 1, wherein at least one of the first and second filter media layers comprises a loading of active particles of at least 50 g/m² and no greater than 600 g/m².

8. The filter cartridge of claim 1, further comprising a housing, wherein the first and second filter media layers, the plenum, and the functional material are disposed within the housing.

9. The filter cartridge of claim 1, further comprising a conduit that extends from the plenum through an opening in the second filter media layer, and a connector connected to the conduit, wherein the second filter media layer is connected to the connector at a connector seal region, wherein the functional material is not disposed in at least a portion of the connector seal region.

10. The filter cartridge of claim 1, further comprising a visual life indicator disposed on the first major surface of the first filter media layer, wherein the visual life indicator comprises a visual filter life indicator zone and a visual reference zone, wherein the visual reference zone includes the functional material and the visual filter life indicator zone is free of the functional material.

11. The filter cartridge of claim 1, wherein the functional material is disposed on the first major surface of the first filter media layer in a first pattern, wherein the functional material is disposed on the first major surface of the second filter media layer in a second pattern, wherein the first pattern is different from the second pattern.

12. A method of forming a filter cartridge comprising:
forming a first filter media layer and a second filter media layer, wherein each of the first and second filter media layers comprises a first major surface and a second major surface;
selectively disposing functional material on the first major surface of each of the first and second filter media layers, wherein the functional material comprises active particles disposed on an adhesive layer;
disposing a plenum between the first and first filter media layers; and
connecting the first filter media layer and the second filter media layer together to form a perimeter seal region that defines at least a portion of a perimeter of the filter cartridge, wherein the functional material is not disposed in at least a portion of the perimeter seal region.

13. The method of claim 12, wherein selectively disposing functional material comprises:
selectively disposing an adhesive layer on the first major surface of each of the first and second filter media layers; and
disposing the active particles on the adhesive layer such that at least a portion of the active particles is attached to the adhesive layer.

14. The method of claim 13, wherein selectively disposing functional material further comprises removing a portion of the active particles that is not attached to the adhesive layer.

15. The method of claim 12, wherein at least one of the first and second filter media layers comprises a loading of active particles of at least 50 g/m² and no greater than 600 g/m².

16. The method claim 12, further comprising disposing a conduit within the filter cartridge such that it extends from the plenum through an opening in the second filter media layer.

17. The method of claim 12, further comprising disposing a front cover web on the first major surface of the first filter media layer.

18. The method of claim 12, further comprising disposing a rear cover web on the first major surface of the second filter media layer.

19. The method of claim 12, wherein selectively disposing functional material further comprises selectively disposing functional material on the first major surface of the first filter media layer in a first pattern and selectively disposing function material on the first major surface of the second filter media layer in a second pattern, wherein the first pattern is different from the second pattern.

20. The method of claim 1, further comprising forming a visual life indicator on the first filter media layer, wherein the visual life indicator comprises a visual filter life indicator zone and a visual reference zone, wherein the visual reference zone includes the functional material and the visual life indicator zone is free of the functional material.
